(19) United States
(12) Patent Application Publication
(10) Pub. No.: US 2016/0018866 A1
(43) Pub. Date: Jan. 21, 2016

(54) System And Method For Storing Manufacturing Information And Lifetime Usage History Of A Power Module For A Memory System

(71) Applicant: Netlist, Inc., Irvine, CA (US)

(72) Inventor: Scott H. Milton, Irvine, CA (US)

(21) Appl. No.: 14/800,629

(22) Filed: Jul. 15, 2015

Related U.S. Application Data
(60) Provisional application No. 62/024,949, filed on Jul. 15, 2014.

(51) Int. Cl. G06F 1/30; G06F 12/02; G06F 1/32; G06F 12/06

(52) U.S. Cl. CPC G06F 1/30; G06F 12/0638; G06F 12/0238; G06F 1/3275; G06F 2212/205; G06F 2212/202

(57) ABSTRACT

A memory system is described. The memory system includes a plurality of memory subsystems. Further, the memory system includes a controller coupled with the plurality of memory subsystems. The memory system also includes a power module including a storage device configured to store information and the power module is detachably coupled with the controller.

### CROSS-REFERENCE TO RELATED APPLICATIONS

This application claims the benefit of U.S. Provisional Patent Application No. 62/024,949, filed Jul. 15, 2014, which is hereby incorporated by reference in its entirety.

### FIELD

Embodiments of the invention relate to memory systems. In particular, embodiments of the invention relate to memory systems with a power module.

### BACKGROUND

A memory system with a secondary power supply such as those that include a volatile memory subsystem and a non-volatile memory subsystem are used to write contents of volatile memory into non-volatile memory, for example in a back-up operation upon detection of a power disruption or an impending disruption or failure. These memory systems include a secondary power supply to power the memory system during a power failure such that the memory system may perform a back-up procedure and transfer the information in the volatile memory subsystem into the non-volatile memory subsystem.

One problem with current memory systems that include a secondary power system is that stored information about the power supply is limited to voltage and temperature. Further, no information about the secondary power supply is stored with the secondary power supply itself, and any information in addition to voltage and temperature is not accessible except through the memory system, which may require removal of the memory system from the host system for access. In addition, if the secondary power supply is removed from the memory system the information is lost and no longer associated with the removed secondary power supply.

### SUMMARY

A memory system is described. The memory system includes a plurality of memory subsystems. Further, the memory system includes a controller coupled with the plurality of memory subsystems. The memory system also includes a power module including a storage device configured to store information and the power module is detachably coupled with the controller.

Other features and advantages of embodiments of the present invention will be apparent from the accompanying drawings and from the detailed description that follows.

### BRIEF DESCRIPTION OF THE DRAWINGS

Embodiments of the present invention are illustrated by way of example and not limitation in the figures of the accompanying drawings, in which like references indicate similar elements and in which:

FIG. 1 illustrates a block diagram of a power module according to an embodiment as part of a memory system; and

FIG. 2 illustrates a flow diagram for a method to store and access information from a power module according to an embodiment.

### DETAILED DESCRIPTION

Embodiments of a memory system with a power module are described. In particular, a memory system with a power module is described that is configured to store information on a storage device on the power module. The information stored on the storage device includes, but is not limited to, manufacturing information and lifetime usage history of the power module. The memory system is configured to access and store information in the storage device on the power module.

A power module including a storage device provides the benefit of including preloaded information relevant to the power supply that may be accessed and/or used by the memory system or a host system coupled with the memory system or any other device coupled to the power module. Because the information is stored on the power module, the information may be used to ensure interoperability of the power module with different memory systems, to ensure proper operation of a memory system with the power system, or to optimize performance of a memory system with the power system. Further, a power module including a storage device provides the benefit that the information being maintained by the power module moves with the power module should the power module be detached from the memory system, for example, for use with a different memory system. This provides the ability to detach a power system from one memory system and use the power system with a second memory system without losing the manufacturing and/or lifetime usage or other static or dynamic information accumulated in the storage device of the power module.

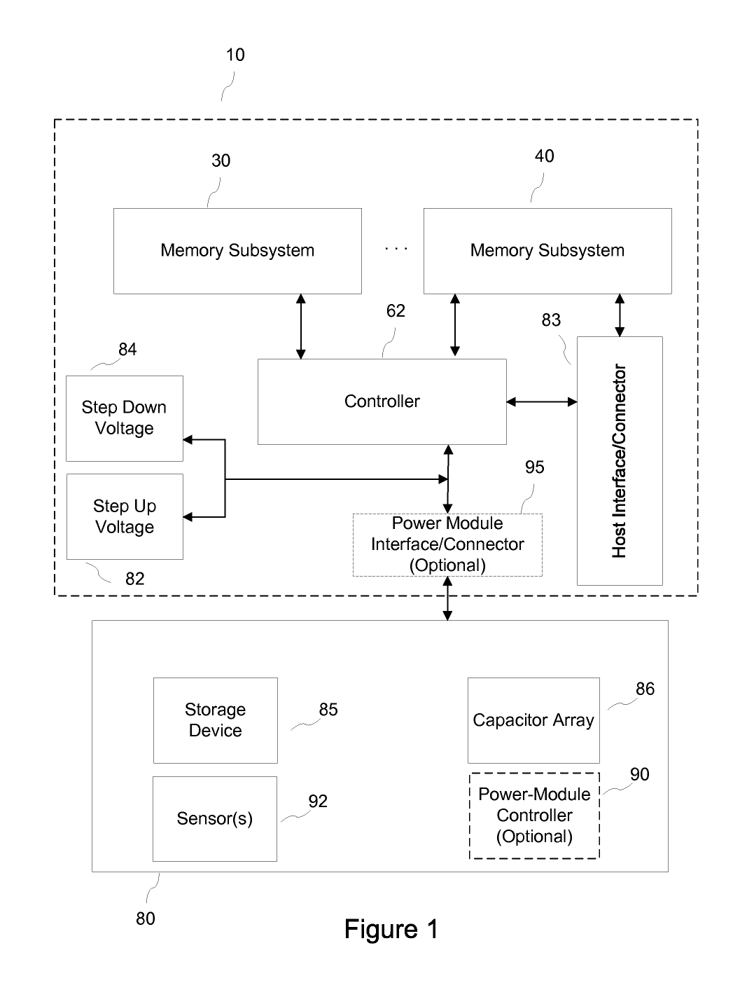

FIG. 1 illustrates a power module 80 according to an embodiment as part of a memory system 10. The memory system includes a plurality of memory subsystems 30, 40. For an embodiment, the plurality of memory subsystems 30, 40 includes at least a volatile memory subsystem 30 and a non-volatile memory subsystem 40. The memory system 10 may also include a step down voltage circuit 84 and/or a step up voltage circuit 82. The step down voltage circuit 84 and the step up voltage circuit 82 may be controlled by the power module 80 to adjust the voltage of the power module 80 to be compatible with one or more components of the memory system 10 and/or to otherwise fine tune the voltage of the power module, for example to optimize performance of the memory system 10. Further, the memory system 10 includes a host interface/connector 83 for connecting with a host system.

The power module includes a storage device 85. The storage device 85 may include any type of non-volatile memory including, but not limited to, read-only memory (ROM), EEPROM, Flash memory, or other types of solid-state non-volatile memory devices used to store information. The storage device 85 is configured to receive information to store in the storage device 85. The power module 80, according to an embodiment, includes one or more of a capacitor bank or array 86 and optionally a connector that interfaces with an power module interface/connector 95 so that the power module 80 may be detachably connected to the controller 62 and the memory system 10. A power module 80 may optionally include a power-module controller 90. A power-module controller 90 includes, but is not limited to, one or more of any of a field-programmable gate array (FPGA), a microcontroller, a memory controller, an I²C microcontroller, and any other type of processor. The power-module controller 90 may be configured to receive, access and store information in the storage device 85; perform tests and measurements; receive commands; respond to commands, fine tune parameters/specifications of the power module, for example, to match the memory system or to make it compatible with voltage/current/power requirement of the memory module (e.g., control a step-up/down voltage converter); control sleep mode to reduce heat generated if the power module is not being used; and other functions including those known in the art.

The memory system 10, according to the embodiment illustrated in FIG. 1, includes a controller 62 coupled with the storage device 85. The controller 62 is configured to access and store information in the storage device 85. The controller 62 may include one or more of a field-programmable gate array (FPGA), a microcontroller, a memory controller, or other type of processor. For an embodiment, the controller 62 is coupled with the storage device using a data bus. A data bus includes, but is not limited to, a parallel bus, a serial bus, Inter-Integrated Circuit (I²C) bus and other interconnections known in the art to transmit and receive data, such as information to store in or access from a storage device 85. For an embodiment the power module 80 is a secondary power source for a memory system 10 that is used to power one or more memory subsystems 30, 40 of the memory system 10. By way of example and not limitation, a power module 80 is used to power at least one volatile-memory subsystem 30, at least one non-volatile memory subsystem 40, and controller 62, such that the controller can control the transfer of information from the volatile memory subsystem 30 to the non-volatile memory subsystem 40 during an interruption or failure of the primary power source of the memory system 10.

The type of information stored in a storage device 85 on a power module 80 includes, but is not limited to, manufacturing information and lifetime usage information. Manufacturing information may include power module serial presence detection of the power module, type/form factor, nominal capacitance, organization of the capacitor array, maximum operating voltage of the power module, maximum operating temperature of the power module, super capacitor manufacture, super capacitor value, super capacitor quantity, power module manufacture, power module manufacturing date, power module serial number, cyclic redundancy check to validate data, power module part number, power module revision and other information related to the power module.

The manufacturing information may be stored as one or more bits in a storage device. For example, power module serial presence detection revision information may be stored as two bytes, one byte for the major revision number and one for the minor revision number, such as the format described in the serial presence detection standard by the Joint Electron Device Engineering Council (JEDEC) for memory modules. The type/form factor may be stored as two bytes to indicate information about the pack, fan assembly, or other specific information about components in the power module. The organization, which is used to describe how the devices are connected to form the power supply for the power module, may be stored as two bytes. For an example, one byte is used to indicate the number of capacitors connected in series and one byte is used to indicate the number of capacitors connected in parallel. The maximum operating voltage may be stored as one byte to indicate the voltage in decivolts (dV). The maximum operating temperature may be stored as one byte to indicate the temperature in units Celsius, Fahrenheit, or Kelvin. The super capacitor manufacture may be stored as one byte that represents a vendor of a capacitor array used for the power source for the power module. The super capacitor value may be stored as two bytes that represents a value of the capacitor array, for example the units of the value may be in Farads. The super capacitor quantity may be stored as one byte that represents the number of capacitors in the capacitor array. The power module manufacture may be stored as two bytes that represent a vendor of the power module. The power module manufacture location may be stored as one byte that represents the location of a vendor of the power module. The manufacture date may be stored as two bytes that represents the date of manufacture of the power module, for an embodiment, this value may be stored as a binary-coded decimal. The power module serial number is stored as 16 bytes, for an embodiment, this value may be stored as ASCII. The cyclic redundancy check to validated data may be stored as two bytes. The power module serial number is stored as 24 bytes, for an embodiment, this value may be stored as ASCII. The power module revision information may be stored as two bytes, one byte for the major revision number and one for the minor revision number.

The storage device may also be configured to store measured usage/lifetime values of the power module. Measured usage/lifetime values include, but are not limited to, first capacitance measured, last capacitance measured, lowest capacitance measured, average capacitance, number of samples used to calculate the average capacitance, last voltage before backup, lowest voltage after backup, last temperature measured, average temperature, number of samples to calculate the average temperature, and the number backup cycles performed using the power module. For an embodiment, the measured usage/lifetime values may be generated by one or more sensors or circuits 92 on the power module or on the memory system. The sensors or circuits 92 include, but not limited to, a measurement integrated circuit to generate voltage, current, and/or temperature measurements, a current sense amplifier, a capacitance measurement circuit, and other sensors or circuits known in the art. One or more measured usage/lifetime values may also be generated by one or more controllers on the memory system or on the power module, for example by using counters, analog to digital convertors, and using other techniques including those known in the art.

The measured usage/lifetime values of the power module may be stored as one or more bits in a storage device. For example, the first capacitance, the last capacitance measured, the lowest capacitance measured, and the average capacitance may be stored as two bytes representing capacitance in deciFarads (dF). The number of capacitance measurement samples may be stored as four bytes and used to calculate the next value of average capacitance. The backup cycles may be stored as two bytes to indicate the count of the number of backup cycles the power module has performed which, for an embodiment, is independent of the number of backup cycles the one or more memory subsystems have performed.

The above manufacturing and measured usage/lifetime values described herein are exemplary and one skilled in the art would understand that other types on information may be stored in the storage device using techniques and formats including those known in the art. Further, the information stored in the power module may be preloaded into the storage device during manufacturing. The information stored in the storage device may be configuration values based on testing, calibration, or predetermined operating characteristics of a power module.

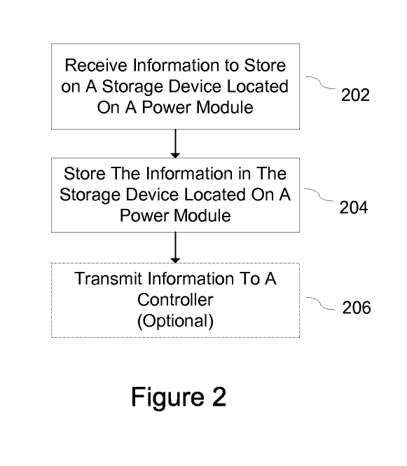

FIG. 2 illustrates a flow diagram for a method to store and access information from a power module according to an embodiment. The method includes receiving information to store on a storage device located on a power module (202). For example, a storage device is configured to receive information over a data bus from a controller using techniques including those known in the art. According to an embodiment the information received is generated by a controller using techniques including those known in the art. The received information may be information to update information already stored in the storage device. The method also includes storing the information in the storage device located on a power module (204). For example, a storage device is configured to store the information in memory addresses using a memory controller using techniques including those know in the art. Further, the method optionally includes transmitting information to a controller (206). For example, the storage device may include a memory controller to retrieve information from one or more address of the storage device for transmitting on a data bus using techniques including those known in the art. Alternatively, a controller is used to request information stored in one or more address of a storage device, for example by

For an embodiment, one or more values, such as manufacturing and measured usage/lifetime values, are updated by the controller during operation of the memory system. The controller may be configured to update the values upon a determination that a value has passed a threshold, a determination that a value has exceeded a percentage of change from the last stored value, after the passage of time, upon a determination that a successful backup has occurred, or based on other criteria or trigger events. For an embodiment, the controller is configured to send a command to the power module. Upon receiving a command, the power module is configured to update one or more values. A command may be one or more bits and includes commands and formats such as those set out in protocols including, but not limited to, I²C, System Management Bus (SMB), Power Management Bus (PMBus), or other parallel or serial bus protocols.

For an embodiment, the controller is configured to read some of the information on power up of the memory system, for example the revision information. For example, the controller is configured to read serial presence detection version values and/or one or more capacitance values from the stored device of the power module. Upon receiving the values from the power module, the controller determines compatibility of the power module with the memory system. If the controller determines that the power module is not compatible, for example the version number is not recognized and/or the capacitance values are not high enough, the controller may trigger an event or otherwise notify a host system. A host system includes, but is not limited to, a storage system, a computer, or other device that incorporates a memory system that includes the power module. For another embodiment, a controller is configured to disable the power module if it is determined not to be compatible. For an embodiment, a controller is configured to access one or more values from the storage device of the power module and store the values in internal registers for quick access by the host system.

The controller, according to an embodiment, is configured to provide direct host access to the information stored on the power module. For example, the controller is configured to receive one or more commands from a host system to access information stored in the storage device of the power module and transmit this information to the host system. The controller may be configured to access information from the power module based on the host system setting a read/write bit, accessing an address register, accessing a data register, setting a control bit, setting a status bit, setting an error bit. Based on a request received from a host system for information stored in the power module, the controller is configured to perform one or more functions including loading an address with information, load data, execute a data transfer, poll status to determine when an operation is complete, read data, and perform a next operation.

For an embodiment, a host is configured to write to a power module address register in the controller on a memory system. For example, a host sends one or more commands to set a read/write bit in the controller of the memory system to indicate the type of access. If the access is a read, the host then sets the read/write bit to read and then sets an access bit in the controller of the memory system to access the power module, for example the access bit may be a power module access bit. The controller of the memory system will then perform the read from the power module using communication techniques including those described herein. Once the read operation is complete, the controller of the memory system will update the data register and then set a status bit to inform the host that the operation has completed successfully. If an error occurs, an error bit will be set. The process for a write operation is similar with the only difference, according to an embodiment, being that the host also writes data to the power module data register in the controller in the memory system and then sets the read/write bit to write before setting the power module access bit. The host will then poll the status bit until the operation is either completed successfully or completed with an error.

In the foregoing specification, specific exemplary embodiments of the invention have been described. It will, however, be evident that various modifications and changes may be made thereto. The specification and drawings are, accordingly, to be regarded in an illustrative rather than a restrictive sense.

What is claimed is:

1. A memory system comprising:
one or more memory subsystems;
a controller coupled with said one or more memory subsystems;
a power module coupled with the memory system and including a storage device configured to store information relating to said power module.

2. The memory system of claim 1, wherein said storage device includes a non-volatile memory device.

3. The memory system of claim 1, wherein said power module is configured to be detached from said memory system.

4. The memory system of claim 1, wherein said storage device is configured to store information including manufacturing information of said power module.

5. The memory system of claim 1, wherein said storage device is configured to store lifetime usage history of said power module.

6. The memory system of claim 5, wherein at least a first one of said one or more memory subsystems includes non-volatile memory.

7. The memory system of claim 6, wherein at least a second one of said one or more memory subsystems includes volatile memory.

8. The memory system of claim 7, wherein said controller is configured to control a transfer of information from said volatile memory to said non-volatile memory.

9. The memory system of claim 5, wherein said lifetime usage history of said power module includes one or more measured usage/lifetime values of said power module.

10. The memory system of claim 9, wherein said controller is configured to update at least one of said one or more measured usage/lifetime values.

11. A method to store information in a storage device of a power module, the method comprising:
receiving first information to store in said storage device located on said power module;
storing said first information in said storage device located on said power module.

12. The method of claim 11, wherein said first information includes manufacturing information of said power module.

13. The method of claim 11, further comprising:
receiving at said storage device a command from a controller; and
transmitting said first information to said controller in response to said command.

14. The method of claim 11, wherein said first information includes one or more measured usage/lifetime values.

15. The method of claim 14, wherein said one or more measured usage/lifetime values include lifetime usage history of said power module.

16. The method of claim 14, further comprising:
generating second information to store in said storage device located on said power module;
transmitting said second information to said storage device; and
storing said second information in said storage device, wherein said second information includes an update to said one or more measured usage/lifetime values.

17. The method of claim 16, wherein generating said second information is performed by a controller of a memory system including one or more memory subsystems.

18. The method of claim 16, wherein generating said second information to store in said storage device located on said power module is in response to a determination that a value passed a threshold.

19. The method of claim 16, wherein generating said second information to store on said storage device located on said power module is in response to a determination that a successful backup has occurred.

20. The method of claim 16, wherein generating said second information to store on said storage device located on said power module is in response to a determination that a value has exceeded a percentage of change from a last stored value.

21. The method of claim 16, wherein said first information or said second information includes a command from said controller.

22. The method of claim 21 further comprising updating said first information or said second information in said storage device located on said power module in response to said command.

23. A power module for a memory system including a plurality of memory subsystems comprising:
means for receiving information to store on a storage device located on said power module;
means for storing said information in said storage device located on said power module; and
means for transmitting said information to a controller.
